(19) United States
(12) Patent Application Publication
(10) Pub. No.: US 2010/0283580 A1
(43) Pub. Date: Nov. 11, 2010

(54) DEVICE AND METHOD FOR DETECTING THE OPENING OF A VESSEL

(75) Inventors: Jun Sheng, Shanghai (CN); Xing Sheng, Shanghai (CN)

Correspondence Address: LOWE HAUPTMAN HAM & BERNER, LLP, 1700 DIAGONAL ROAD, SUITE 300, ALEXANDRIA, VA, 22314, US

(73) Assignee: SHANGHAI INVENT LOGISTIC AND TECHNOLOGY CO., LTD., Shanghai (CN)

(21) Appl. No.: 12/864,021

(22) PCT Filed: Jan. 4, 2009
(86) PCT No.: PCT/CN09/70017

§ 371 Date: Jul. 22, 2010

(30) Foreign Application Priority Data
Jan. 24, 2008 (CN) 200810033041.5

(51) Int. Cl. G06F 7/00; H01Q 1/24

(52) U.S. Cl. 340/5.31; 343/702

(57) ABSTRACT

A device and a method for detecting the opening of a vessel are disclosed, the device includes: a control circuit which stores and provides the identification data, an antenna which is connected to the control circuit forms a circuit loop together with the control circuit, and the antenna has an extending unit; the antenna provides the communication channel to the control circuit; the antenna and its extending unit and the control circuit are attached to the vessel, when the vessel is open, the antenna, the circuit loop or the control circuit is destroyed, thus the control circuit cannot provide the identification data. With the device and method, the vessel, such as container, is prevented from being illegally opened or replaced without knowing in the transporting or keeping process.

### FIELD OF THE ART

The present invention relates to a device and method for detecting the opening of a vessel, more particularly, relating to an apparatus and method that identifies whether lock(s) or door(s) of a container has been opened.

### BACKGROUND OF THE ART

Locks are used commonly in our daily life and work as anti-theft devices. Generally, users require that locks have a certain physical strength to cause difficulty for plunderers to damage the locks violently. In addition, users require that locks are highly secure, that is, for a mechanical lock, a plug mechanism need to be able to prevent the mechanical lock from being opened illicitly by a copied key; for a coded electronic lock, the lock code need to be confidential and cannot be decoded.

With the development of business, locks are used on vessels that ship cargos, such as, freight containers. In this case, freight containers are sealed by locks before shipping and are examined whether have been damaged or opened illicitly when shipped at the destination. It should be noted that some plunderers restore locks to their original state after the plunderers have broken or illicitly opened the locks to steal cargos or replace cargos with illegal articles which makes it impossible to discover the fact that the locks have been damaged or opened illicitly. Therefore, when such locks are examined at the destination, it is impossible to discover the fact that such locks have been damaged or opened illicitly. Taking the containers as an example, it was recently found in some costal ports that export cargos in export containers, which are loaded with cargoes and sealed at the warehouse and shipped to docks by trucks, have been stolen with container seals in good condition. An investigation revealed that while stealing, a theft gang removed the rivet fixed on the latch mechanism of a container door and then opened the container door to steal. After the export cargos were taken out, the plunderers shut off the container door, re-fixed the rivet on the latch mechanism thereof without damaging the seal and delivered the stolen containers into the dock. Therefore, it was impossible to discover in time that such locks of container had been opened. When loaded with cargos and its doors closed, a container has always been secured by a sealing device which seals a hole of a door handle and a hole of a hasp of the container door. In logistic chain, one basic way to confirm responsibility is to see whether a container seal is intact or not. As in the above-mentioned case, it was generally impossible to find out any traces that the export cargos had been stolen, and it brought huge losses to the export companies whose cargoes were in severe shortage while the packages and seals of the containers were in sound condition when arriving in the imported country, which, as well, arising many international compensation disputes and adversely affect the credit of export enterprises.

For detecting locks that have been damaged or opened illicitly in time, a patent (Patent No. 200610029886.8) discloses a container anti-theft tracking system which comprises: after container doors are closed, a disposable tracking locking mechanism is adapted for locking a locking bar's head with a socket and the tracking locking mechanism is made in materials that might be broken under force; a bar code attached to the tracking locking mechanism, a tracking device for scanning the data included in the bar code and transmitting such data; a server for receiving and displaying any data transmitted by a data acquisition device.

Comparing to a traditional lock, the anti-theft lock disclosed by the above identified patent has certain improvement and is easy to manufacture in low costs. It can be used to detect whether a container lock has been opened illicitly by common lawbreakers but is not sufficient to detect any illicit opening by special and well-trained lawbreakers. For example, in shipping, in place of opening the container doors firstly, the lawbreaker will firstly cut off an anti-theft lock and then open the container doors to take cargos out or put illegal articles in (such as drugs, weapons) for smuggling out; later they will shut off the container doors and restore the cut-off anti-theft lock, such as, using an adhesive to bind/stick the cut off anti-theft lock together and then attaching a bar code which is reproduced beforehand/in advance. However, under this condition, it is rather difficult to detect whether the anti-theft lock is damaged; therefore, it is easy to pass the customs inspection. Once the customs inspection is finished, illegal articles carried in the container will be taken away secretly.

### BRIEF DESCRIPTION OF THE PRESENT INVENTION

One of the technical problems to be solved by the present invention is that providing an apparatus for identifying whether a vessel (such as a container) has been opened.

Another one of the technical problems to be solved by the present invention is to solve is that providing an apparatus that identifies whether a vessel (such as a container) has been opened, for distinguishing whether a vessel has been restored after being opened illicitly.

For solving the above-identified technical problems, the present invention provides an apparatus that identifies whether a vessel has been opened, comprising:

a control circuit (722) for storing and providing identification data;

an antenna (721) connected to said control circuit (722);

said antenna and said control circuit forming a circuit loop;

said antenna providing a communication channel to said control circuit (722);

one portion or the entire of said antenna or one portion or the entire of said control circuit attached to said vessel, wherein, once said vessel opens, said antenna, circuit loop or control circuit is damaged to prevent said control circuit from providing identification data.

For solving the above-identified technical problems, the present invention also provides an apparatus that identifies whether a vessel has been opened, comprising:

a control circuit (722) for storing and providing identification data;

an antenna (721) connected to the control circuit (722), said antenna having an extending unit (728), combining with said extending unit of said antenna, said control circuit forms a circuit loop;

a main locking mechanism (407, 408) disposed on said vessel, wherein said extending unit of said antenna circles or pass through said main locking mechanism;

a tracking locking mechanism (201, 202), wherein said antenna, said extending unit of said antenna and said control circuit are attached on said tracking locking mechanism, once said main locking mechanism opens, said antenna, circuit loop or control circuit disposed on the tracking locking mechanism is damaged to prevent the control circuit from providing identification data.

To solve the above-identified technical problems, additionally, the present invention provides an apparatus which identifies whether a vessel has been opened, comprising:

a control circuit (722) for storing and providing identification data;

an antenna (721) connected to the control circuit, combining with said antenna, said control circuit forming a circuit loop;

a main locking mechanism attached on said vessel (407, 408);

a tracking locking mechanism (201, 202), said antenna and the control circuit are attached on said tracking locking mechanism, said tracking locking mechanism disposed on said main locking mechanism; wherein once the main locking mechanism opens, said antenna, circuit loop or control circuit on the tracking locking mechanism is damaged to prevent the control circuit from providing identification data.

The apparatus described in the present invention for identifying whether a vessel has been opened can effectively prevent the container from being opened illicitly without any awareness in shipping or under safekeeping. More specifically, the present invention can be applied on cargo containers to effectively prevent lawbreakers from stealing cargos and using containers to carry illegal articles secretly.

### BRIEF DESCRIPTION OF DRAWINGS

FIG. 1A shows a schematic of an identification circuit 101 for a main locking mechanism of the present invention;

FIG. 1B shows a schematic of an identification circuit 102 for the main locking mechanism of the present invention;

FIG. 2A shows a schematic of a tracking locking mechanism 201 for the main locking mechanism;

FIG. 2B shows a schematic of the tracking locking mechanism 202 for the main locking mechanism;

FIG. 3A shows a method of installing identification circuits on the tracking locking mechanism;

FIG. 3B is an exemplary embodiment of the identification circuits attached on a paper material.

FIG. 4 shows a schematic of a container 400;

FIG. 5 shows a schematic of the cooperation between a locking bar head 406 and a container socket 407;

FIG. 6A shows a schematic of the cooperation among the tracking locking mechanism 201, the container socket 407 and the locking bar head 406.

FIG. 6B shows a schematic of the cooperation among a tracking locking mechanism 202, a container socket 407 and a locking bar head 406.

FIG. 7A shows a circuit diagram for a communication device 710 and a transponder 720;

FIG. 7B shows a circuit diagram for a communication device 710 and a transponder 720;

FIG. 8 shows a schematic of data transmitting process of the present invention;

FIG. 9 is a flow chart describing a method for identifying whether a vessel has been opened;

FIG. 10 is a flow chart describing a method and a process for a container anti-theft tracking of the present invention;

Wherein, marks among the figures are as follows:

| | |
|---|---|
| 101 an identification circuit | 102 an identification circuit |
| 201 a tracking locking mechanism | 202 a tracking locking mechanism |
| 211 a hasp string of a tracking lock mechanism | 221 a hasp string of a tracking locking mechanism |
| 212 a locking head of a tracking locking mechanism | 222 a shrinkable tape |
| 213 a hasp of a tracking locking mechanism | 223 a hasp of a tracking locking mechanism |
| 214 a locking pin of a tracking locking mechanism | 224 a locking pin of a tracking locking mechanism |
| 215 an upper arm of a tracking locking mechanism | 216 a lower arm of a tracking locking mechanism |
| 217 a concave of a tracking locking mechanism | 301 a top view of a tracking locking mechanism |
| 302 a top view of an identification circuit 101 | 303 a top view of an identification circuit 102 |
| 304 a substrate | 305A a flexible film material |
| 305B a flexible film material | 305C a flexible film material |
| 306 a thin sheet for an identification circuit | 307 a thin sheet for an identification circuit |
| 308 a break line | 400 a container |
| 401 a container body | 402 a container left door |
| 403 a container right door | 404 a container locking bar |
| 405 a handle of a container locking bar | 406 a container locking bar head |
| 407 a socket for a container locking head | 408 a latch mechanism for a container locking bar |
| 409 a container base plate | 561 a U-shaped Part |
| 562 a U-shaped Part | 563 an aperture |
| 564 a connection part | 571 a right arm |
| 572 a left arm | 573 a bedding plate |
| 574 an aperture | 575 an upper projection |
| 576 a lower projection | 710 a communication device |
| 711 an antenna | 712 an radio frequency interface |
| 713 a control module | 720 a transponder |
| 721 an antenna | 722 a control circuit |
| 723 a communication link for signals | 724 an I/O line |
| 725 MPU | 726 ROM |
| 727 RAM | 728 an extending unit of an antenna |
| 817 a data acquisition device | 818 a display of a data acquisition device |
| 819 a function key of a data acquisition device | 820 a battery for a data acquisition device |
| 821 an acquisition device of a data acquisition | 822 an inspection server |
| device | |

### DETAILED DESCRIPTION OF THE PRESENT INVENTION

A detailed description of the present identification apparatus and the method thereof will be described as follows with the references to the figures.

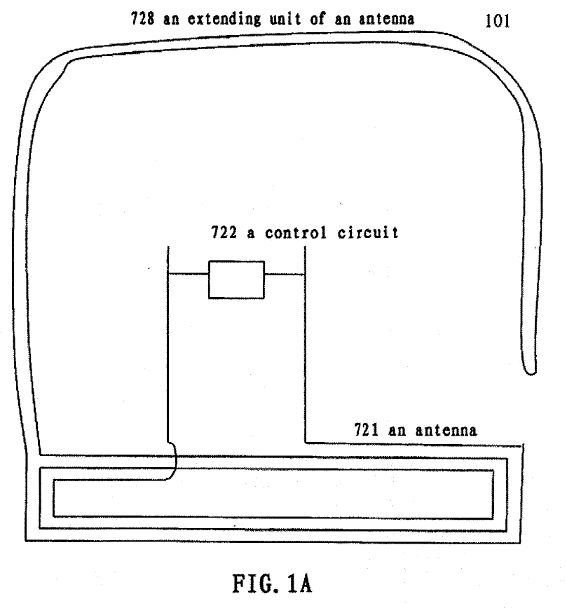

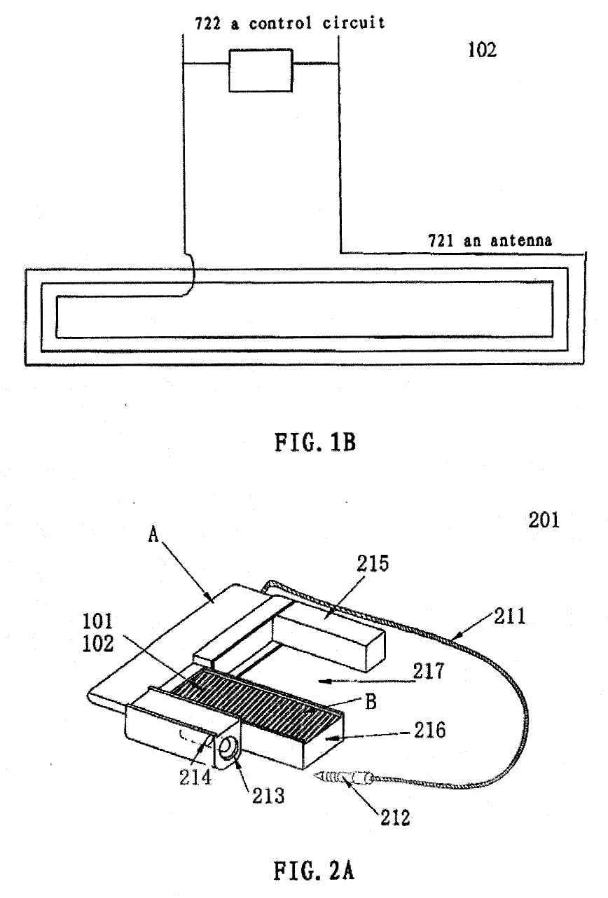

FIG. 1A depicts an identification circuit 101 of the present invention. As shown in FIG. 1A, the identification circuit 101 comprises a control circuit 722 (data chip), an antenna 721 and an extending unit of the antenna 728. The control circuit 722 is used for controlling, storing, providing and processing data. The antenna 721 is coupled to the control circuit 722, and the antenna 721, the extending unit of the antenna 728 and the control circuit 722 form a circuit loop. In operation, the antenna 721 and the extending unit of the antenna 728 (utilizing the power generated by the antenna's inductance) provide electric power to the control circuit 722 and provide a communication port for a data acquisition circuit.

In operation, the antenna 721 and the control circuit 722 can be attached to a vessel (such as, a main locking mechanism of a container), and the extending unit of the antenna 728 may be circled or pass through the main locking mechanism. Once the main locking mechanism is damaged or opened illicitly, the control circuit 722, or, the antenna 721 or the extending unit of the antenna 728 will be damaged to stop the entire circuit loop from working and thereby from reading data. In FIG. 1A, the surface of the antenna 721 needs to be larger than that of the prior art to have larger contact with the surface of the vessel to be identified. Because the antenna has an extending unit, the entire antenna will still have larger contact with the vessel to be identified even if the surface of the antenna is not large enough and therefore, the identification accuracy will not be affected.

FIG. 1B depicts an identification circuit 102 of the present invention. The identification circuit 102 in FIG. 1B is similar to the identification circuit 101 in FIG. 1A in use and principle, but the difference lies in that the identification circuit 102 has no extending unit. As the antenna in FIG. 1B has no extending unit, and, therefore, the surface of the antenna is larger than that of the antenna in FIG. 1A for having larger contact surface area with the vessel to be identified to ensure the accuracy of identification.

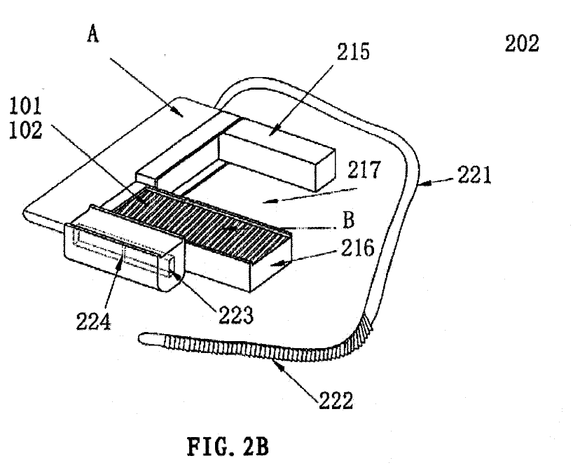

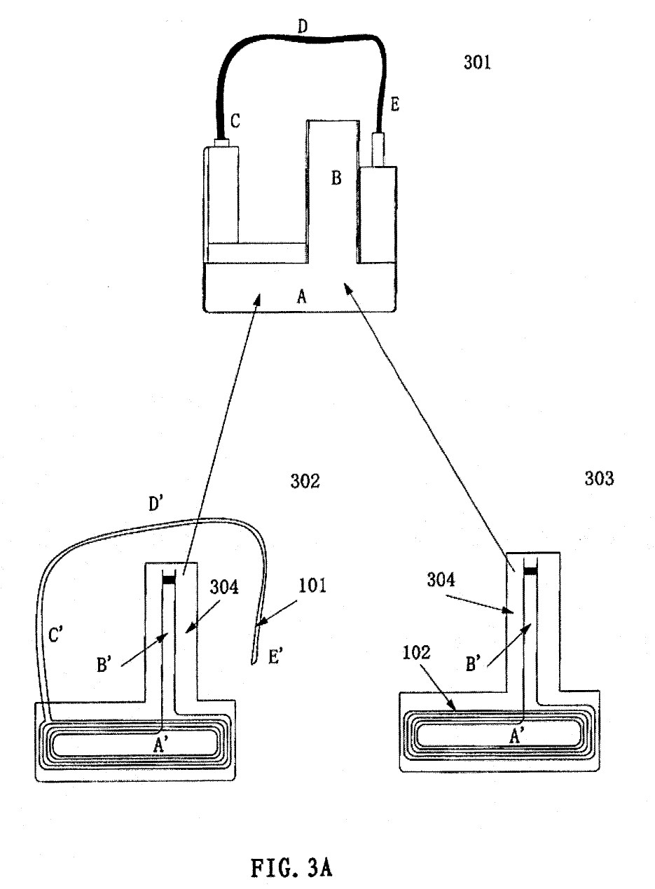

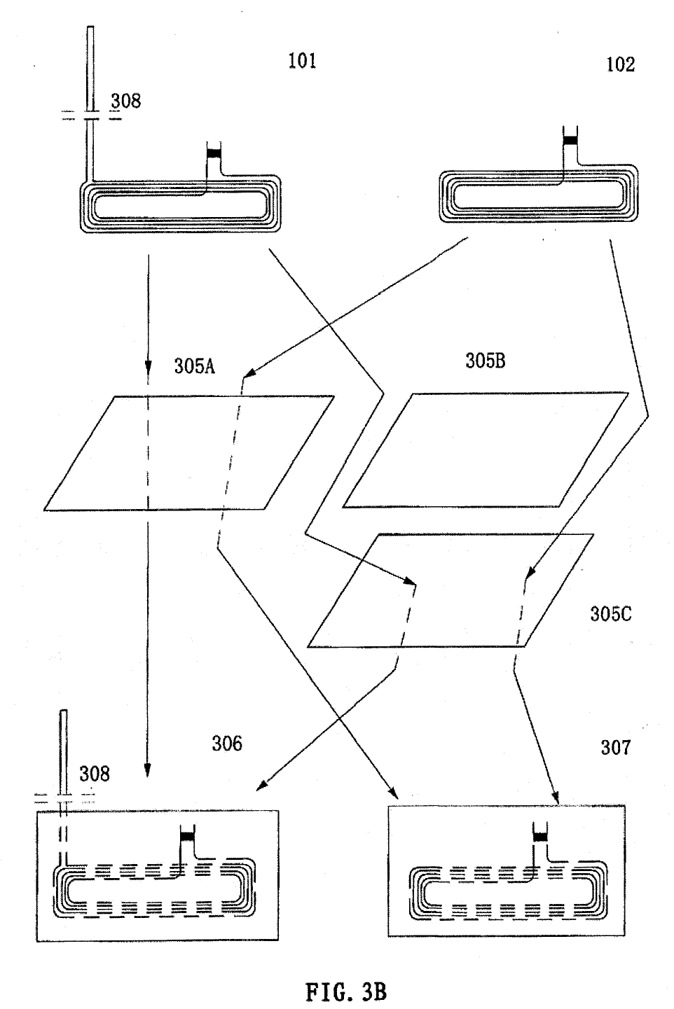

FIG. 2A depicts an embodiment of a tracking locking mechanism 201 of the present invention. As shown in FIG. 2A, the tracking locking mechanism 201 comprises a hasp string 211, a locking head 212, a hasp 213, a locking pin 214, an upper arm 215, a lower arm 216 and an identification circuit 101 or an identification circuit 102. There is a concave 217 in between the upper arm 215 and the lower arm 216. The locking head 212 is inserted into the hasp 213 and firmly locked by the locking pin 214. The identification circuit 101, 102 is attached on the tracking locking mechanism 201 and the extending unit of the antenna 728 may be mounted on the hasp string 211. The antenna 721 may be adjusted in according to the shape of the tracking locking mechanism 201 to have the circuit loop formed by the antenna and control circuit distributed on the cross section and vertical section of the tracking locking mechanism 201 (see FIG. 3A).

FIG. 2B is another embodiment of the tracking locking mechanism 201 according to the present invention. A tracking locking mechanism 202 is similar to the tracking locking mechanism 201 but the difference lies in that the locking head 212 in the tracking locking mechanism 202 is replaced with a shrinkable tape 222 which matches with the locking pin 224 and the hasp 223. The shrinkable tape of the prior art is usually made in plastics with round or square cross sections. There are saw-toothed striations over the surface of the shrinkable tape with round cross sections or over one side of the shrinkable tape with square sections. When the shrinkable tape 222 is inserted into the hasp 223, a projected locking pin 224 inside the hasp 223 catches one end of the shrinkable tape 222 which then can only make one-way movement due to the structure feature and the shrinkable tape becomes tighter and tighter as it is inserted deeper into the aperture of the hasp 223.

FIG. 3A is a chart showing the method of installing the identification circuit on the tracking locking mechanism. 301 is a top view of the tracking locking mechanism. 302 is a top view of the identification circuit 101. 303 is a top view of the identification circuit 102.

The identification circuit 101 can be adhered to a substrate 304 which is then attached to the tracking locking mechanism using a high-strength adhesive. The material for the substrate needs to be suitable for forming the control circuits and antennas. The substrate may be made in paper, plastics or other materials. Forming the identification circuit on the substrate will enhance the intensity of the identification circuit and make it convenient for installation. When installing the identification circuit 101 on the tracking locking mechanism, the antenna area A′ and the control circuit area B′ of the identification circuit are coincided with the area A and B of the tracking locking mechanism, respectively; The area C′, D′ and E′ for the extending unit of the antenna are coincided with the hasp string area C, D and E of the tracking locking mechanism, respectively. The identification circuit can also be placed inside the tracking locking mechanism to be manufactured together with the tracking locking mechanism.

As the circuit loop is attached on both the cross and vertical sections of the tracking locking mechanism, the extending unit of the antenna will be cut off if the hasp string is sheared off; If the tracking locking mechanism is damaged violently, the antenna will be damaged when the damage is made to the area A of the tracking locking mechanism, and the control circuit, or the interconnection between the control circuit and the antenna will be damaged when the damage is made to the area B of the tracking locking mechanism. In brief, once the tracking locking mechanism is damaged, the circuit loop will be damaged accordingly and the data in the circuit cannot be read, thereby, it can be detected that the main locking mechanism has been opened.

When the identification circuit 102, of which the antenna having no extending unit, is attached on the tracking locking mechanism, the antenna area A′ and the control circuit area B′ are coincided with the area A and B of the tracking locking mechanism, respectively. Therefore, the circuit loop in the area A and B will be damaged, if the damage is made to the area A and B of the tracking locking mechanism. In addition, as no circuit loop is attached on the area C, D, E of the tracking locking mechanism, the circuit loop will not be damaged even if the hasp string is cut off, and, the tracking locking mechanism will be damaged if mechanical damages are made to the C, D, E area of the tracking locking mechanism. However, restoring the cut-off hasp string will cause damages to the area A and B of the tracking locking mechanism. As the antenna has no extending unit, the identification circuit 102 is easier to be made, to be installed on a tracking locking mechanism and costs less. Because the antenna has no extending unit, the surface of the antenna is to be larger enough to have sufficient contact with the surface of the tracking locking mechanism to ensure the identification accuracy.

FIG. 3B is an exemplary embodiment view of the identification circuits attached to a paper material.

The identification circuit 101 can as well be adhered to a flexible film material 305 (such as high-intensity tissue paper or plastic tissue paper) using glue to form an identification circuit board 306. The identification circuit 101 is drawn in dotted lines and indicated at the back of the paper which thereby is invisible. 308 are two break lines indicating that only a portion of the length of the extending unit of the antenna is drawn. In the same way, the identification circuit 102 is attached to a flexible film material (such as high-intensity tissue paper or plastic tissue paper) to form an identification circuit 307.

In addition, the identification circuit 101, 102 can be adhered in between a flexible film material 305 B and 305 C (such as high-intensity tissue paper or plastic tissue paper) using glue to form the identification circuit board 306 or 307.

The identification circuit boards 306 and 307 are widely used, and can be used on various doors and locks. For example, attach the identification circuit board 306 and 307 on the connection part between two closed doors using high intensity adhesive, and wrap up the handles, locks or other objects with the extending unit. Once the door is opened, the disposable identification circuit board 306 and 307 will be damaged. In addition, as the identification circuit board 306 and 307 is adhered to the doors using high intensity adhesive, it will be damaged if taken off the doors. The identification circuit boards 306 and 307 can also be attached on a conventional lock using high intensity adhesive. As the antenna is long and thin and if the lock is opened, the identification circuit board 306 and 307 will be damaged and the circuit loop will stop working which causing to identify the lock has been opened.

The identification circuit boards 306 and 307 can also be used on various vessels (such as paper boxes, paper packages, metal boxes, metal packages, drink cans, drink bottles, drink boxes, safes, glass vessels, glass bottles, and alcohol bottles) by simply attaching it to the opening position. Once the vessel is opened from the opening position, the identification circuit board 306 and 307 will be damaged and the circuit loop inside will stop working which thereby causing to identify the vessel has been opened.

For the convenience of manufacturing and installation, the identification circuit 101 and 102 may be installed on the substrate 304 firstly (as shown in 302 and 303 of FIG. 3A), and then the whole is installed on a flexible film material 305A or in between 305B and 305C to form the identification circuit board 306 and 307 as shown in FIG. 3B.

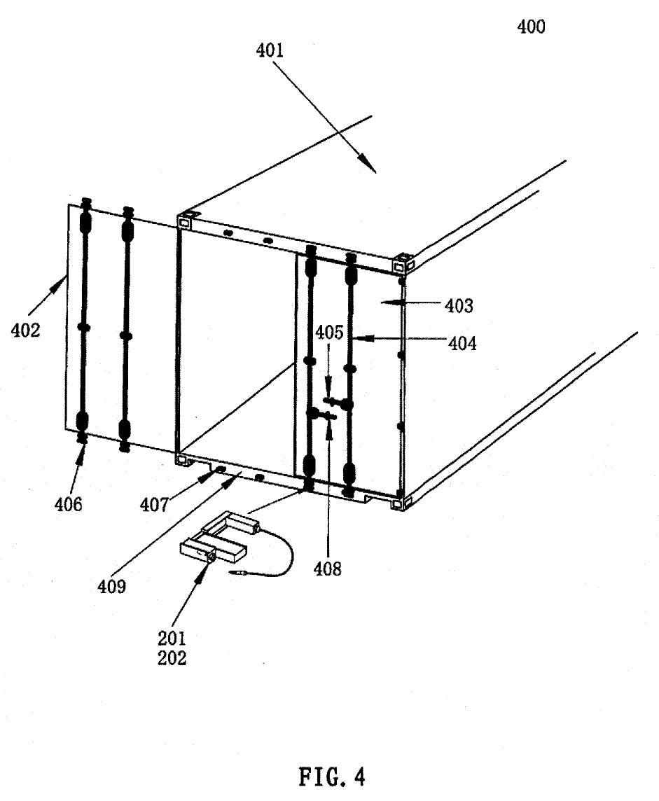

FIG. 4 is a schematic diagram of a container 400 (a shipping vessel). The container 400 comprises a container body 401 having two doors 402 and 403 at one end of the container body. Each of the doors has two locking bars 404 and each of the locking bars has a handle 405. When the handle 405 is rotated, the attached locking bar is driven to be moved. The door is locked when two handles 405 attached to the locking bars on the same door are rotated together and parallel to each other. There is a locking bar head 406 at each end of the locking bar 404. The locking bar head 406 is used to lock the socket 407 attached on the bottom plate of the container 409. The container doors are sealed when two handles 405 attached to the same locking bar are rotated together and parallel to the container doors 402 and 403, and inserted into two latch mechanisms 408 on the container doors. A main locking mechanism for a container comprises the locking bar 404, the handle 405, the locking bar head 406, the socket 407 and the latch mechanism 408.

At present, the container doors 402 and 403 follow a principal and subordinate relation, namely, one door 403 as the principal door and the other door 402 as the subordinate door. When the container doors are closed, the edge of the principle door is pressed on the edge of the subordinate door. When the container doors need to be opened, the subordinate door will be opened only after the principal door is opened. Therefore, the tracking locking mechanisms 201 and 202 need be only installed on the door 403 which working as the principal door in the present embodiment. The tracking locking mechanisms 201 or 202 has to be installed respectively on both of the doors which do not follow a principal and subordinate relation and, therefore, no repeated description will be given herein.

The tracking locking mechanism in the embodiment of the present invention is installed on the container locking head 406 at the lower end of the locking bar 404 and the socket 407 at the bottom plate of the container. The tracking locking mechanism can also be installed on the locking head 406 at the upper end of the locking bar 404 and the socket 407 at the roof of the container. The tracking locking mechanism can even be installed on the connection part where the handle 405 is inserted into the latch mechanism 408 of the container.

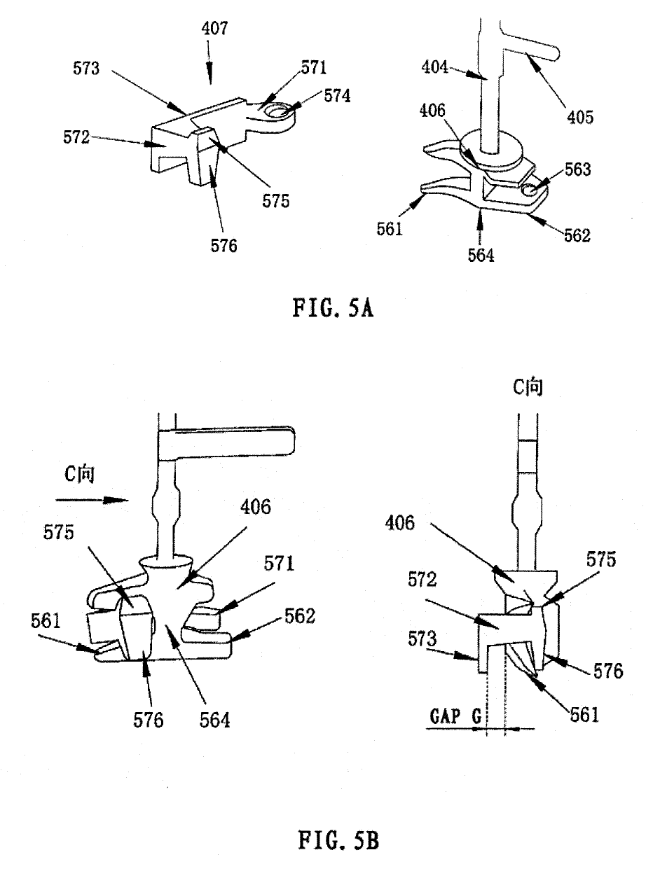

FIG. 5A is a skeptical view of the structures of the container socket 407 and the locking bar head 406 when separated. The socket 407 comprises of a bedding plate 573, a left arm 572 on the left end of the bedding plate and a right arm 571 on the right end of the bedding plate. The two arms and the bedding plate from a Π shape. In addition, there is an aperture 574 on the front end of the right arm 571. There are two projections on each side of the front end of the left arm 572, namely, an upper projection 575 and a lower projection 576. Each side of the locking bar head 406 generally forms a U shape, namely, a U shaped part 561 and a U shaped part 562 whose arm having an aperture 563. The joint in between the two U shaped parts (or the middle portion of the locking bar head 406) can be caught by Π then shaped concave of the socket 407.

FIG. 5B is an assembly view of the container socket 407 and the locking bar head 406. As the handle 405 and the locking bar head 406 are attached to the locking bar axis and are made as a whole, when the handle 405 is rotated counterclockwise for being parallel with the container doors (a process to close the opening container door), the locking bar head 406 is rotated counterclockwise as well. In rotating, the U shaped part 561 on the locking bar head catches the left arm 572 of the socket, and the projections on the front end of the left arm 572 hold the U shaped part 561 preventing the U shaped part 561 from moving forward, and the bedding plate 573 prevents the U shaped part 561 from moving backward. The right arm 571 of the socket 407 is surrounded by the U shaped part 562 of the locking bar head 406. The aperture 574 on the right arm 571 is coincided with the aperture 563 on the U shaped part 562 and a string or a pin (such as a hasp string) can be inserted through the aligned apertures. When the handle 405 is rotated counterclockwise and parallel with the container doors, a gap G is formed in between the bedding plate 573 of the socket 407 and the locking bar head 406 (as shown in the left view taking along Direction D) and the tracking locking mechanism 201 or 202 can be inserted through such gap.

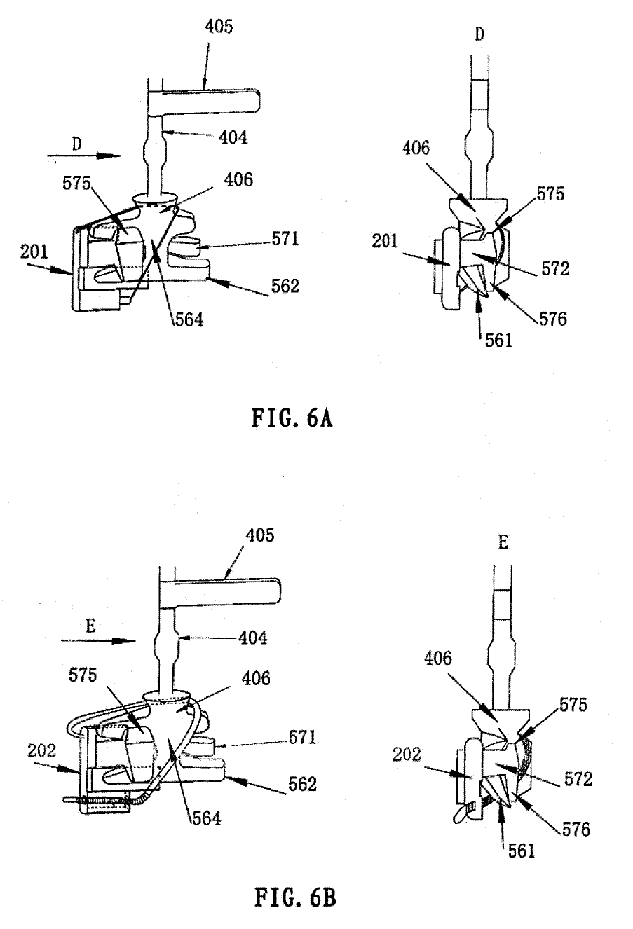

FIG. 6A is an assembly chart of the tracking locking mechanism 201, the container socket 407 and the locking bar head 406. The tracking locking mechanism 201 is inserted through the gap G in between the socket 407 and the locking bar head 406 (as shown in the left view taking along Direction D), and a concave 217 of the tracking locking mechanism is caught by a left arm 572 of the socket 407. The locking bar head 406 is wrapped up by the hasp string 201 of the tracking locking mechanism. Upon the locking head 212 being inserted into the hasp 213, the tracking locking mechanism firmly locks the socket 407 and the locking bar head 406. The socket 407 and the locking bar head 406 will be as well locked by inserting the hasp string 211 through the aperture 563 on the locking bar head 406 and the aperture 574 on the socket 407. In this case, the length of the hasp string 211 is fixed according to the integration among the tracking locking mechanism 201, the socket 407 and the locking bar head 406.

FIG. 6B is an assembly drawing of the tracking lock 202, the socket 407 and the locking bar head 406. FIG. 6B is similar to FIG. 6A but their difference is that, the shrinkable tape 222 connected to one end of the hasp string 221 is inserted into the aperture of the hasp 223 and is tightened for the tracking locking mechanism to firmly lock the socket 407 and the locking bar head 406.

As shown in FIGS. 4, 5A, 5B, 6A and 6B, the tracking locking mechanism 201 and 202 are disposable and made of materials which broken under pressure (such as plastics). To open the doors 402 and 403 for unloading cargos, the handle 405 attached to the container locking bar has to be rotated which lifts the locking bar head 406 causing the gap between the socket 407 and the locking bar head 406 to diminish and the socket 407 and the locking bar head 406 to smash the tracking locking mechanism 201 or 202. Before opening the container doors to unload cargos, the tracking locking mechanism can be removed by shearing off the hasp string which also causing damages to the circuit loop of the identification circuit.

Therefore, provide that the container doors 402 and 403 is opened, the tracking locking mechanism 201 or 202 of the present invention will be broken and cannot be restored to its original state. The identification circuit 101 or 102 will be damaged as well and, simultaneously, the data on the control circuit 722 (data chip) of the tracking locking mechanism will be damaged and then lost irreversibly, which thereby precluding the theft of export cargos or the phenomenon of replacing export cargos with substitutes without breaking the seals secured on the container doors upon the containers being loaded.

Barcodes (which is not shown in the figures) and the control circuit 722 (data chip) are attached to the tracking locking mechanisms 201 and 202 of the present invention, and the password data for such tracking locking mechanism is installed on the control circuit (data chip). Such password data is only and unique and, for example, can be produced by a secret stochastic algorithm.

To guard thoroughly against theft and the act of replacing cargos with illegal articles secretly in the containers shipping, the apparatus and method thereof disclosed in the present invention that identifies whether a vessel has been opened is effect in precluding lawbreaking and criminal activities, such as, theft and the act of replacing cargos with illegal articles secretly in the whole logistic chain, and thereby protecting the rights of shippers. Recently, all countries have joined the Solas Convention, and to an extending unit, the present invention can be used to prevent terrorists from carrying illegal articles secretly in containers or other conducing terrorist activities. As the present invention is made of materials which broken under pressure and is locked directly on the locking bar head at the bottom end and the socket at the bottom end of the container door, the tracking locking mechanism for the container will be broken and cannot be restored to its original state provided the container door is opened. As the tracking locking mechanism disclosed in the present invention has a barcode and data chip, and when containers being picked up, loaded and sealed at a warehouse, shipped to a port, ready for shipment, a data acquisition device is used to scan such barcode and data chip into a scan-transmitting and send the information, such as, the tracking locking mechanism data recorded, sealing date and time, to relevant enterprises and authorities via wireless acquisition system. Each data acquisition device has a system identification number and is equipped with a GPS global position system for tracking the position of every truck in shipping. Because the latch mechanism is welded at a container door, removing the attached latch mechanism of the container door will damage the container body and cause damages to the tracking locking mechanism. Therefore, the container anti-theft and tracking apparatus is really effect in theft prevention and tracking, and is also flexible, safe and widely applicable.

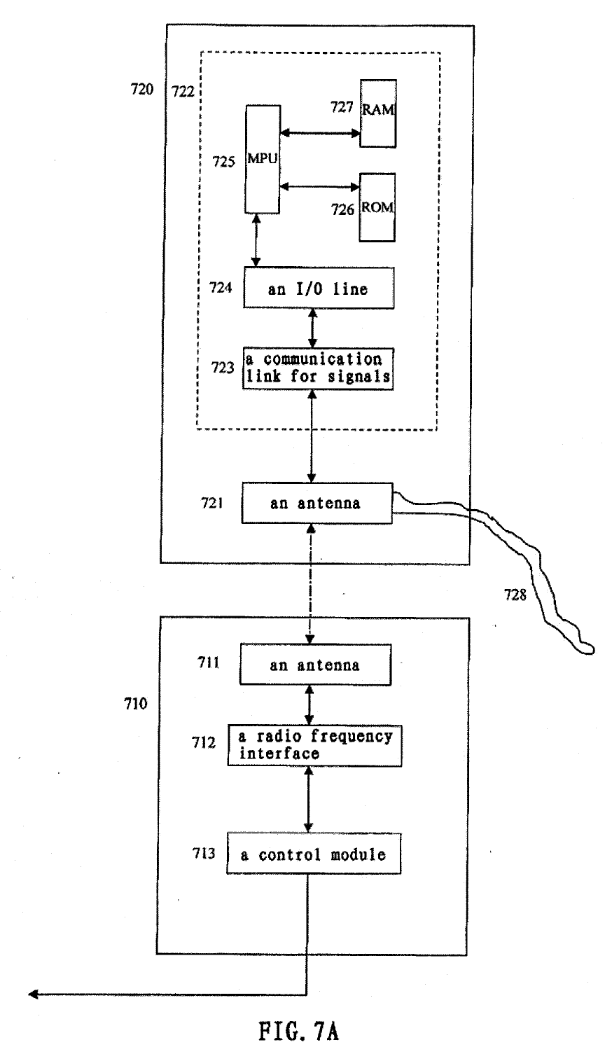

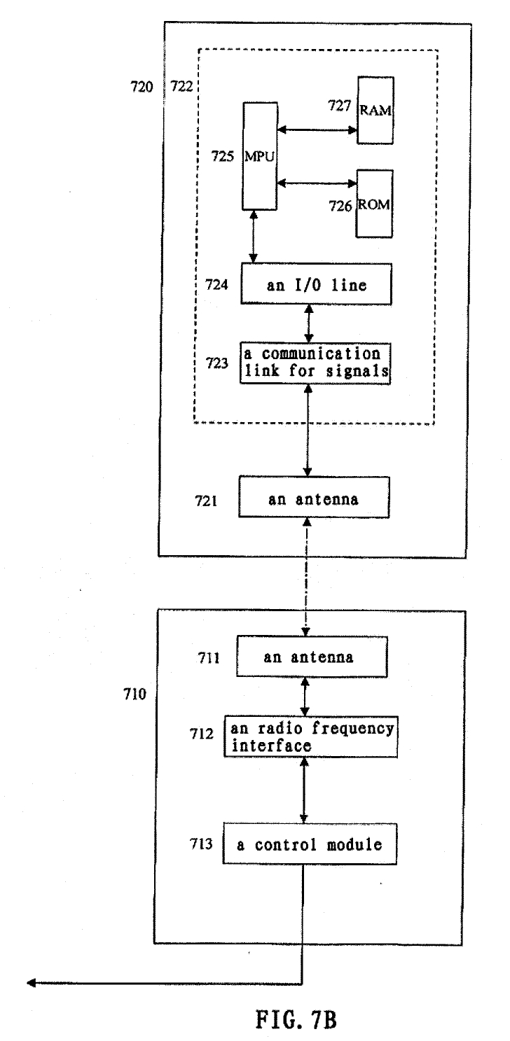

FIGS. 7A and 7B are flow charts showing the communication function realized by the control circuit and a data acquisition system.

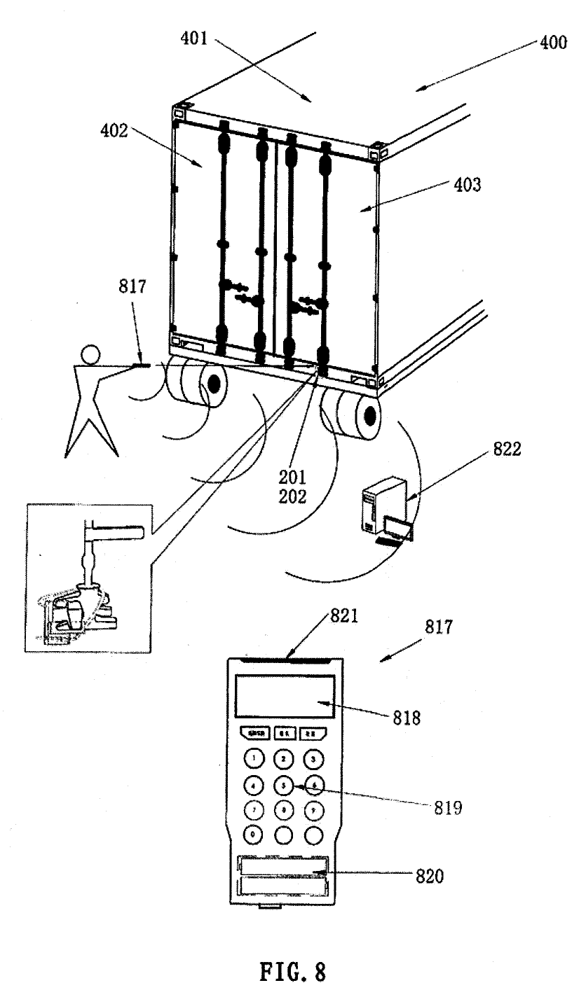

FIG. 7A is a structure drawing of a transponder 720 (which comprises the control circuit 722, the antenna 721 and an extending unit of the antenna 728) and a communication device 710 (as one part of a data acquisition device 817 shown in FIG. 8).

The communication device 710 comprises of the antenna 711, RF interface 712 and control module 713. The transponder in FIG. 7A is powerless and the communication device 710 and the antenna 711 provide power for its operation. The signals between communication device 710 and 720 are transmitted via the antenna 711 and 721. When approaching to the transponder 720, the communication device 710 provides electromagnetic energy to the antenna 721 whose inductance generating power to activate the circuit in the transponder 720. A control module 713 is used to activate the RF interface 712 which transmitting signals to the transponder 720, receiving signal from the transponder 720, and intermediately storing signals received.

The transponder 720 comprises of the antenna 721 and control circuit 722. The antenna 721, which has an extending unit 728, can convert numbers or signals into electromagnetic signal and communicates with the antenna 711 in the communication device 710.

The control circuit 722 includes a MPU (Micro Processor Unit) 725 which is connected to a RAM 727 and a ROM 726, respectively. The RAM 727 and ROM 726 are used for storing instructions and data, and password data, chip identification ID and user password of the transponder 720 are stored in the ROM 726 which cannot be modified; When being produced, it should be ensured that each control circuit 722 has one unique chip identification ID, and password data and chip identification ID are produced by a algorithm kept in secret. One unique user code is assigned to each user and can be written into ROM 726 when being produced. Upon reading the data out of the control circuit 722, either the chip identification ID or the password data, or the chip identification ID, password data and user code can be used for identifying the transponder 720 for prevention counterfeits.

MPU 725 can directly access to data in the RAM 727, but can only read data in ROM 726 after writing them into it. An I/O line 724 is used for temporarily storing data between the MPU 725 and a communication link for signals 723. When sending signals, MPU 725 transmits data produced by an algorithm to the I/O line 724 and the communication link for signals 723 converts the data into energy to activate the antenna 721 for generating signals. Upon receiving signals, the communication link for signals 723 converts the signals of the antenna 721 which is in the form of electromagnetic energy of into digital signals and then store them in I/O line 724 for MPU 725 to read.

FIG. 7B is a working flow chart of a communication device 710 and a transponder 720. FIG. 7B is similar to FIG. 7A, but the difference is that the antenna 721 in the transponder 720 has no extending unit 728.

It should be mentioned that, the control circuit 722 and the antenna 721 in the present invention can be realized through the Radio Frequency Identification (RFID) circuit and the antennas of the prior art with modification. Comparing to the Radio Frequency Identification Circuit of the art, the surface of the antenna 721 is much larger. As to the Radio Frequency Identification circuit of the prior art, the antenna should be smaller and smaller provided the function is realized. However, the antenna 721 needs a certain contact with the vessel to be identified or the tracking locking mechanism of the present invention.

FIG. 8 is a skeptical view of a data transmitting program of the present invention. The apparatus that identifies whether a vessel has been opened disclosed in the present invention is applied on containers as a container anti-theft and tracking system, which comprises of the tracking locking mechanism 201 or 202 described above in detail, a data acquisition device 817 having a communication device 710 and using for scanning and transmitting the control circuit 722 (data chip) and the barcode of the tracking locking mechanism 201 or 202; an inspection server 822 using for receiving and displaying the data transmitted by the data acquisition device 817.

When the container 400 loaded with cargos and sealed by a tracking lock 201 or 202 and placed for shipment at a dock of a port, shipped or picked up, a data acquisition component 821 of the data acquisition device 817 is used to scan the barcode and control circuit (722) of the tracking lock 201 or 202 of the container 400. The data acquisition device 817 will send data obtained to an inspection server 822 through function keys 819. Information such as the data of the tracking lock, sealing date and time will be displayed and stored on the inspection server 822. The data acquisition device 817 will send data such as the time when the container is picked up, loaded, sealed, and arriving at a port to the inspection server 822 which will send such data to relevant enterprises and authorities.

The data acquisition device 817 is installed a GPS global position system and therefore, has a GPS system identification number. Relevant departments in charge can track the position of every container truck in shipping. As shown in FIG. 8, the data acquisition device 817 is tracking device having a monitor screen 818, function keys 819, a data acquisition component 821, GPS global position system and other components.

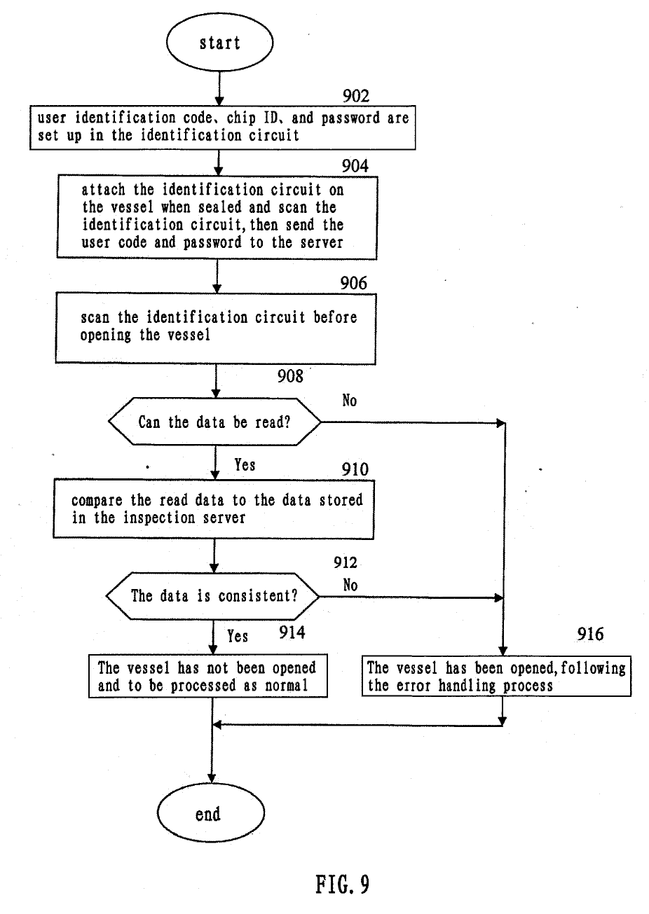

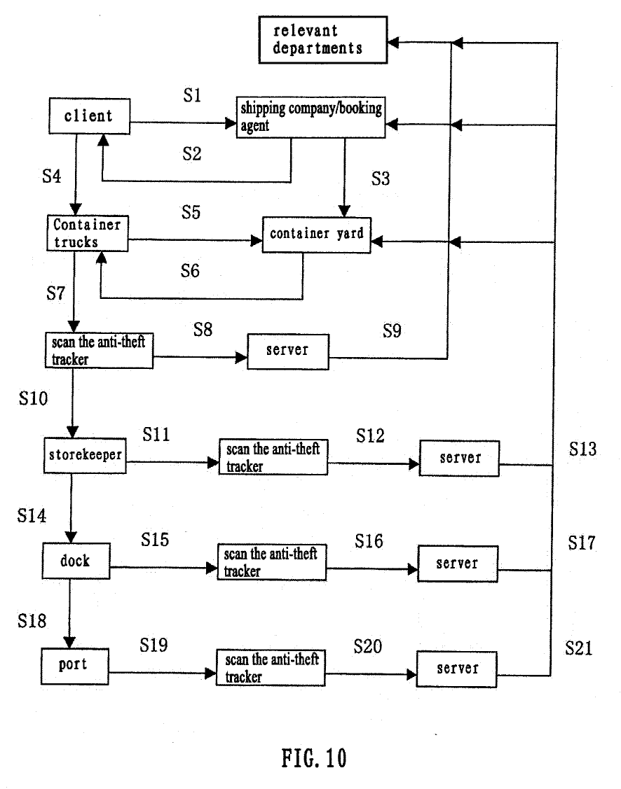

FIG. 9 is a flow chart showing the method of using the identification circuit of the present invention to identify whether a vessel (such as a container) has been opened illicitly.

As shown in FIG. 9, in the step 902, when the identification circuit is sold to a user, three data segments are set up in the identification circuit. The first segment is a user identification code and one unique user identification code is assigned to one user. The second segment is a chip ID; the third segment is a password for the identification circuit. The chip ID and password are produced in secret and one unique, unchangeable chip ID and password are assigned to one data chip. Although an RFID circuit is used in the aforementioned embodiment of the present invention, to one of the skill in the art, writing data into a control circuit is a conventional art and, therefore, no detail description will be given.

In the step 904, attach the identification circuit on the vessel when sealed and scan the identification circuit using a data acquisition device 817 to send the user code and password to an inspection server 822 for storage via wire or wireless network.

In the step 906, scan the identification circuit using a data acquisition device before opening the vessel.

In the step 908, if the data fails to be read, it indicates that the vessel has been opened which leads to step 916 of the error handling process indicating the identification circuit is damaged.

In the step 908, if the data is readable, it will lead to step 910 where the data read and received by the inspection server is compared to the data stored in the inspection server. The data read includes password data, chip ID and user code.

In the step 912, if the data read fails to find corresponding data (the corresponding data includes password data, chip ID and user code), it indicates the data is wrong and leads to step 916 of the error handling process indicating the identification circuit has been substituted and sending the error information back to the data acquisition device.

In the step 912, if the data read find corresponding data (the corresponding data includes password data, chip ID and user code), it indicates the data are consistent and leads to step 914 indicating the vessel has not been opened and to be processed as normal and sending the information of a normal state back to the data acquisition device.

It is very difficult to decode the password data as the password data set up in the control circuit 722 (chip data) are unique and irreproducible for the tracking locking mechanism (such as the password data and chip ID generated using a confidential algorithm) and it is more difficult to decode the password data when the password data/chip ID has to be used with the user code. The limited shipping time of containers (vessel) also adds difficulty to decode the password data. Therefore, even the container (vessel) has been opened illicitly and restored with a new data chip, it still can be identified.

FIG. 10 is a flow chart of a more detailed container anti-theft tracking method and procedure of the present invention.

S1, a client books shipping space with a shipping company or a booking agent.

S2, the shipping company confirms a booking number with the client.

S3, the shipping company informs the delivering schedule in the container yard.

S4, the client or a shipping agent hires a container shipping company (container trucks) for loading containers at the client's warehouse.

S5, the container shipping company obtains a container equipment interchange receipt and container anti-theft tracking locking mechanism from the office (at the container yard) of the shipping company

S6, the office of the shipping company at the container yard removes the cover of the barcode and attach it on the equipment interchange receipt while providing the equipment interchange receipt and the container anti-theft tracking locking mechanism to the container truck company.

S7, use a data acquisition device to scan the data chip and barcode of said container anti-theft tracking locking mechanism and then utilize function keys on the data acquisition device for inputting the number of the fetched container.

S8, the data acquisition device will transmit “barcode data/password of the data chip”, and container number to a designated server via wireless transmitting system (the container number of the container to be picked up is input the data acquisition device through function keys).

S9, upon receiving the data, the server will automatically check with the “barcode data and/or password data on the data chip” (as such information including the container number and barcode data and/or password data on the data chip” of the tracking locking mechanism is stored in the server beforehand, the server will send information to the data acquisition device automatically indicating the container tracking locking mechanism is invalid when the information obtained is inconsistent with the stored information, that is, when a fake container tracking locking mechanism is used), and send the pick-up information, including, the “barcode data and/or password data on the data chip” of the tracking locking mechanism, pick-up time, to the shipping company, ports, and relevant authorities via interne, and store the relevant information in the system and set up the pick-up time in the data acquisition device.

S10, upon completing the container pick-up procedure, the container truck company ships the containers to the client's warehouse for loading with the data acquisition device and the container anti-theft tracking locking mechanism. After the container sealed and the data acquisition device setting up the date, time of sealing, scanning the container, transmit the “barcode data and/or password data on the data chip”, pick-up time, sealing date, time of the container to the server.

S11, when completing loading and under the supervision of client's storekeeper, the container truck company shuts off the container door and locks the container door with the container anti-theft tracking locking mechanism at a designated place, namely, at least the place where a container locking bar head catches a socket on the container bottom plate having one container anti-theft tracking locking mechanism.

S12, transmit data to a designated server via a data acquisition, wireless system.

S13, upon receiving the sealing information, the server automatically checks with the pick-up data stored in its system (when the server finds any inconsistency with the data scanned at the pick-up time, it sends data to the date acquisition device indicating invalid data), and sends the container sealing information to the shipping company, dock and other relevant departments via interne as well as storing the sealing information in its system.

S14, the container truck company ships the containers to the dock and gives the data acquisition device to the container terminal inspector when entering the gate.

S15, the inspector at the terminal entrance scans the barcode/or data chip on the tracking locking mechanism by infrared rays, checks with the container number on the equipment interchange receipt and sends information of data to a designated server by the data acquisition device.

S16, the server checks with the information automatically upon receiving it from the data acquisition device and sends information like valid data or invalid data back to the data acquisition device.

S17, the server will send container gate-in information to the shipping company, the port authority and relevant departments.

S18, when the container is shipped to a designated yard, the data acquisition device is given to management personnel of the port.

S19, the management personnel will input the container yard number to the data acquisition device.

S20, the data acquisition device will send information such as the position of container yard to the server.

S21, the server will immediately send the information regarding the position of container yard to the shipping company, the port authority, the ocean shipping tally company, the customs and other relevant departments and storage all pick-up information, loading and sealing information, container gate-in information and position of container yard in the server's system for records.

It will occur to one of the ordinary skill in the art that said embodiments are given by exemplifying the present invention but not limiting it. Any modifications or changes made to the disclosed embodiments will be in the scope of the claims of the present invention as long as they are in the scope of the substantial spirit of the present invention. For example, it is described as to how to identify whether shipping containers have been opened in the present invention, but the present invention also applies to train containers, auto containers and other containers.

1. An apparatus that identifies whether a vessel has been opened, comprising of:
a control circuit, for storing and providing identification data;
an antenna connected to the control circuit;
said antenna and control circuit forming a circuit loop;
said antenna providing a communication channel to said control circuit;
one portion or the entire of said antenna or control circuit attached to said vessel, and upon said vessel being opened, said antenna, circuit loop or control circuit being damaged to stop said control circuit from providing identification data.

2. An identification apparatus as claim 1, wherein said antenna has an extending unit, and one portion or the entire of the extending unit of the antenna is attached to said vessel.

3. An identification apparatus as claim 2, wherein said identification data are passwords data, chip ID or user codes.

4. An identification apparatus as claim 3, wherein said vessel has a main locking mechanism, which is circled or pass through by said extending unit of the antenna, and once said main locking mechanism is opened, the antenna, the circuit loop or the control circuit will be damaged to stop the control circuit from providing identification data.

5. An identification apparatus as claim 4, wherein said identification apparatus comprises a tracking locking mechanism, on which said antenna, extending unit of the antenna and the control circuit are installed, attached to said mater locking mechanism and upon said mater locking mechanism being opened, said antenna, circuit loop or control circuit on the tracking locking mechanism will be damaged to stop the control circuit from providing identification data.

6. An identification apparatus as claim 5, wherein said tracking locking mechanism has a hasp string, for circling or inserting through the main locking mechanism, and said extending unit of the antenna is mounted within said hasp string of the tracking locking mechanism.

7. An identification apparatus as claim 2, wherein said antenna, the extending unit of the antenna and the control circuit are installed on a flexible film material, which is used to attach on said vessel, and once said vessel is opened, said flexible film material will be damaged which therefore leading to damages to said antenna, circuit loop or control circuit and stopping the control circuit from providing identification data.

8. An identification apparatus as claim 2, wherein said antenna, the extending unit of the antenna and the control circuit are installed between two flexible film materials to form a sheet, which is used to attach on said vessel, and once said vessel is opened, said sheet will be damaged which therefore leading to damages to said antenna, circuit loop or control circuit and stopping control circuit from providing identification data.

9. An identification apparatus as claim 1, wherein data stored in the control circuit can be read by a data acquisition device and while reading data, the data acquisition device provides electric power to said control circuit via said antenna and said control circuit provides data to said data acquisition device via said antenna.

10. An apparatus that identifies whether a vessel has been opened, comprising of
a control circuit (722), for storing and providing identification data;
an antenna (721) connected to the control circuit;
said antenna having an extending unit together with the control circuit forming a circuit loop;
said vessel having a main locking mechanism which being circled or inserted through by said extending unit of the antenna;
a tracking locking mechanism, on which said antenna, extending unit of the antenna and the control circuit are installed, and attached to said mater locking mechanism; upon said mater locking mechanism being opened, said antenna, circuit loop or control circuit attached to the tracking locking mechanism being damaged which stopping the control circuit from providing identification data.

11. An identification apparatus as claim 10, wherein said identification data includes stored passwords data, chip ID or user codes.

12. An identification apparatus as claim 11, wherein said tracking locking mechanism has a hasp string, for circling or inserting through the main locking mechanism, and said extending unit of the antenna is mounted within said hasp string of the tracking locking mechanism.

13. An identification apparatus as claim 12, wherein said antenna is used to provide a communication channel to said control circuit

14. An identification apparatus as claim 13, wherein data stored in the control circuit can be read by a data acquisition device and while reading data, the data acquisition device provides electric power to said control circuit via said antenna and said control circuit provides data to said data acquisition device via said antenna.

15. An identification apparatus as claim 14, wherein said vessel refers to a container.

16. A control circuit, for storing and providing identification data;
an antenna connected to the control circuit and together with the control circuit forming a control circuit;
said vessel having a main locking mechanism;
a tracking locking mechanism, on which said antenna and the control circuit installed, attached to said mater locking mechanism; upon the mater locking mechanism being opened, said antenna, circuit loop or control circuit on the tracking locking mechanism being damaged which stopping the control circuit from providing identification data.

17. An identification apparatus as claim 16, wherein said identification data includes stored passwords data, chip ID or user codes.

18. An identification apparatus as claim 17, wherein said tracking locking mechanism has a hasp string, for wrapping up or inserting through the main locking mechanism.

19. An identification apparatus as claim 18, wherein said antenna is used to provide a communication channel to said control circuit.

20. An identification apparatus as claim 19, wherein data stored in the control circuit can be read by a data acquisition device and while reading data, the data acquisition device provides electric power to said control circuit via said antenna and said control circuit provides data to said data acquisition device via said antenna.

21. An identification apparatus as claim 20, wherein said vessel refers to a container.
